(19) United States
(12) Patent Application Publication
(10) Pub. No.: US 2026/0277762 A1
(43) Pub. Date: Sep. 17, 2026

(54) PRINT PERFORMANCE STATISTICS GENERATION MECHANISM

(71) Applicant: Walter F. Kailey, Boulder, CO (US)

(72) Inventor: Walter F. Kailey, Boulder, CO (US)

(73) Assignee: Ricoh Company, Ltd., Tokyo (JP)

(21) Appl. No.: 19/077,145

(22) Filed: Mar. 12, 2025

(51) Int. Cl. G06F 11/34; G06F 3/12; G06F 11/30

(52) U.S. Cl. CPC G06F 11/3409; G06F 3/1208; G06F 3/1259; G06F 3/1274; G06F 11/3013

(57) ABSTRACT

A printing system is disclosed. The printing system includes at least one physical memory device to store performance statistics logic and one or more processors coupled with the at least one physical memory device to execute the performance statistics logic to receive performance data generated at a printing subsystem during printing of a print job, retrieve current performance statistics data associated with the performance data from one of a plurality of statistical registers, generate updated performance statistics data based on the performance data and the current performance statistics data and store the updated performance statistics data in the one statistical register.

### FIELD OF THE INVENTION

The invention relates to the field of printing systems, and in particular, to processing print images.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and two tandem print engines for duplex printing that include one or more printhead assemblies, where each assembly includes a printhead controller and a printhead (or array of printheads). Each printhead includes many nozzles (e.g., inkjet nozzles) for the ejection of ink or any colorant suitable for printing on a medium.

### SUMMARY

In one embodiment, a system is disclosed. The system includes at least one physical memory device to store performance statistics logic and one or more processors coupled with the at least one physical memory device to execute the performance statistics logic to receive performance data generated at a printing subsystem during printing of a print job, retrieve current performance statistics data associated with the performance data from one of a plurality of statistical registers, generate updated performance statistics data based on the performance data and the current performance statistics data and store the updated performance statistics data in the one statistical register.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2 is a block diagram illustrating one embodiment of a print controller;

FIG. 3 is a block diagram illustrating another embodiment of a print controller;

FIG. 4 illustrates one embodiment of a performance statistics module;

FIG. 5 illustrates one embodiment of a performance interface;

FIG. 6 is a flow diagram illustrating one embodiment for processing performance data;

FIG. 7 is a flow diagram illustrating one embodiment of a process for merging remote statistics;

FIG. 8 is a flow diagram illustrating one embodiment of a process for generating performance statistics traces;

FIGS. 9A and 9B is a flow diagram illustrating one embodiment of a process performed upon completion of a print job; and

FIG. 10 illustrates one embodiment of a computer system.

### DETAILED DESCRIPTION

Continuous form printers often produce print jobs having tens of thousands of meters of paper. Paper width, printer resolution, image bit depth, and number of colors in use determine that gigabytes of data are computed in real time to specify images applied to each meter of paper. Current products feature paper speeds over 100 meters per minute, and speeds are trending higher over time. The application therefore requires state-of-the-art high performance computing. To obtain computational throughput on the order of a hundred trillion integer operations per second, control units include multiple hardware nodes, each executing multiple processes in parallel during printing.

To facilitate problem resolution, each process on each hardware node of the control unit logs its processing steps so that problems during a print job run can be analyzed. The logs are written to memory buffers, rather than files, for performance purposes. Due to limited memory resources, the logs often overwrite (or “wrap”) memory within each log buffer numerous times during a long print run. Thus, an operator is required to stop the printer and request that the buffers be written to disk whenever a problem is detected. Certain events during printing, such as performance problems or errors, can also trigger saving of the trace buffers.

When performance problems occur during printing, data buffering within the control unit, combined with the high speed of the paper, often result in logs that show the root cause of the problems having been eliminated by buffer wrapping. Also, printer settings and printer hardware configuration are crucial to performance analysis. However, these settings and configurations are not captured in a permanent format until a log entry (or trace) is saved after the printer has stopped. As a result, important printer settings and configuration information may be lost if a problem occurred or a setting was changed before the trace was saved.

A performance statistics generation mechanism is described. In one embodiment, the performance statistics generation mechanism is performed by a processing thread executed on each of a plurality of hardware nodes within the control unit. In the following description, for the purposes of explanation, numerous specific details are set forth to provide a thorough understanding of the present invention.

It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, “calculator” and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

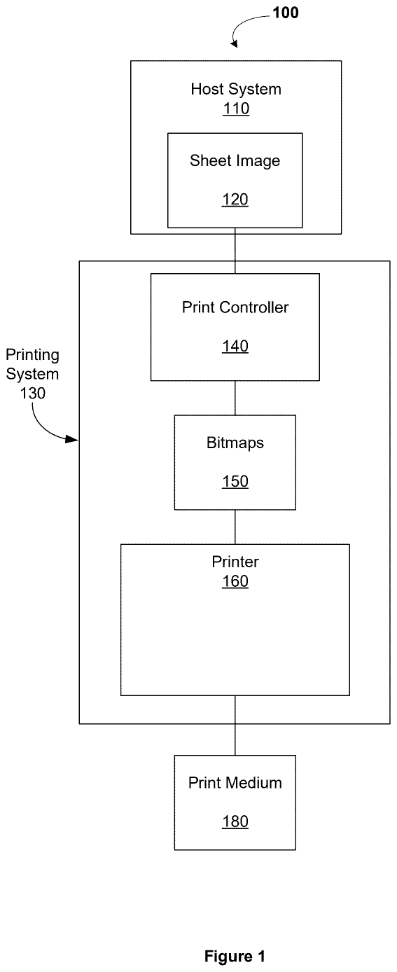

FIG. 1 illustrates one embodiment of a printing system 100. Printing system 100 includes a host system 110 and a printing system 130. Host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, cloud infrastructure, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 having one or more print engines to present the bitmap 150 onto the print medium 180 via marking material (e.g., toner, ink, coatings, etc.) based on the sheet image 120.

Print controller 140 and printer 160 may both be implemented in the same printing system 130 or implemented separately and coupled together. In another embodiment, print controller 140 may be implemented in host system 110 and coupled to printer 160. Print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities.

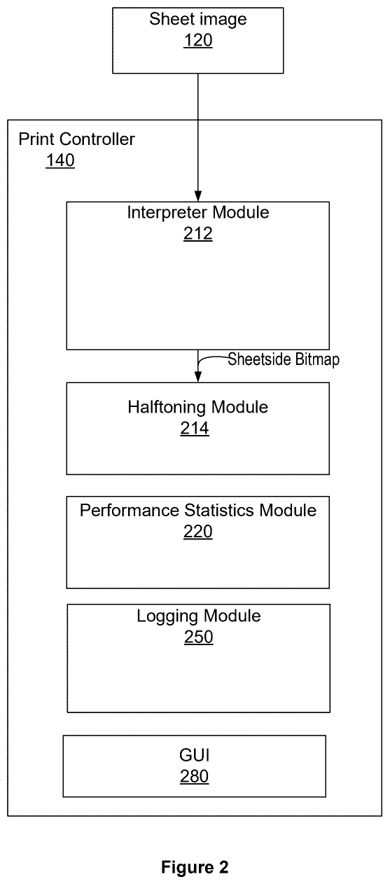

FIG. 2 illustrate one embodiment of a print controller 140. As shown in FIG. 2, print controller 140 (e.g., DFE or digital front end), in its generalized form, includes interpreter module 212, halftoning module 214, performance statistics module 220, logging module 250 and graphical user interface (GUI) 280. Interpreter module 212 is operable to process a print job. In one embodiment, print job processing comprises interpreting, rendering, rasterizing, or otherwise converting images (e.g., raw sheetside images such as sheet image 120) of a print job into sheetside bitmaps.

The sheetside bitmaps generated by interpreter module 212 are each a 2-dimensional array of pixels representing an image of the print job (e.g., a contone image or Continuous Tone Image (CTI)), also referred to as full sheetside bitmaps. The 2-dimensional pixel arrays are considered “full” sheetside bitmaps because the bitmaps include the entire set of pixels for the image. In one embodiment, interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel color values to output drop sizes based on pixel location. Drop size selection based on the contone value of a single pel is referred to as “Point Operation” halftoning. The drop size selection is based on the contone pel values in the sheetside bitmap. This contrasts with “Neighborhood Operation” halftoning, where multiple pels in the vicinity of the pel being printed are used to determine the drop size. Examples of neighborhood operation halftoning include the well-known error diffusion method.

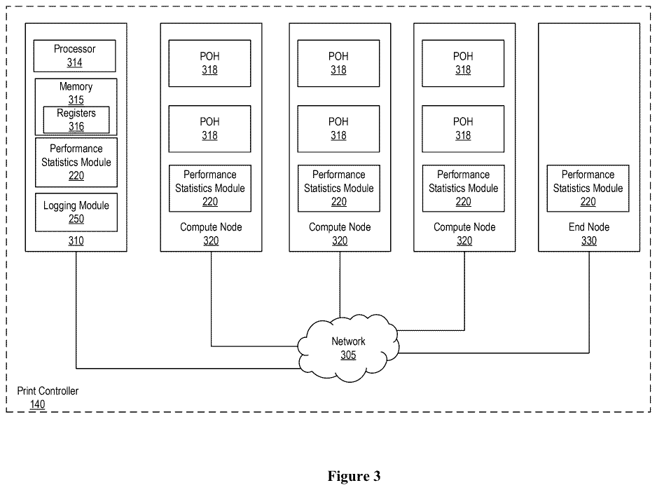

FIG. 3 is a block diagram illustrating another embodiment of print controller 140 implemented as a distributed computing system. In embodiments, each of the components within the print controller 140 distributed computing system may comprise a combination of hardware processors, memories, and/or interfaces of a production printer. Sheetside images generated by print controller 140 are provided to printer 160 for printing. In this embodiment, print controller 140 includes a head node 310, comprising a processor 314 and memory 315, as well as multiple compute nodes 320 and one or more end nodes 330. Each head node 310, compute node 320, and end node 330 of the print controller 140 may comprise an independent, physically distinct computing system (e.g., a “hardware node”), such as an independent computer housed in a case or slot.

Compute node 320 implements one or more Page Object Handlers (POHs) 318. Each POH 318 may be implemented by a separate processor or set of processors of a compute node 320. Communications between head node 310, compute nodes 320 and end nodes 330 may be performed via a network 305 that is private and internal, or conceivably, even the Internet. The various components of the print controller 140 may together implement, or be referred to as the DFE.

Processor 314 of the head node 310 may perform initial processing of print data for a print job, and/or impositioning. During impositioning, print data is arranged into sheetsides stored in memory. The sheetsides of print data are transmitted by processor 314 to various ones of the POHs 318 of the compute nodes 320 for further processing (e.g., rasterization), based on the current processing loads of the POHs 318.

Each POH 318 engages in rasterization processing of a sheetside of print data in order to generate a sheetside image (e.g., a bitmap). In some embodiments a POH 318 may perform further processing such as bitmap scaling, halftoning, post processing (e.g., the application of special marks onto the page), etc. However, in many embodiments these post-rasterization processes may be performed at an end node 330. Thus, a POH 318 may additionally transmit sheetside images to an end node 330. The end node 330 may perform halftoning, the addition of special marks, and other post-processing before transmitting the series of sheet sides in pre-determined order to printer 160. In this manner, an end node 330 may control printer 160 based on input from a variety of POHs 318 as print medium 180 proceeds through printer 160.

In one embodiment, end node 330 of the print controller 140 may handle rasterized data by performing halftoning and/or post-processing on bitmaps from the compute nodes 320, and then export processed bitmaps to printer 160 for printing. Depending on the embodiment, there may be one or more (e.g., two) end nodes 330 per print engine within printer 160. In this embodiment, the end node 330 communicates with printer 160 via a dedicated communications link that is capable of handling a notable amount of data throughput. In this embodiment, the combination of printer 160 and print controller 140 comprises printing system 130.

As each of the components (or processes or sub-systems) within print controller 140 performs processing, it may independently store a log trace indicating processing events that have occurred. These processing events may occur on a millisecond scale, or even faster. As discussed above, log traces are often eliminated due to buffer wrapping.

According to one embodiment, each print controller 140 node includes a performance statistics module 220 to generate performance statistics data for each sub-system within a node. For example, performance statistics module 220 generates performance statistics data (e.g., performance data) for each process (e.g., imposition, rasterization, post-rasterization, halftoning, etc.) performed within a node.

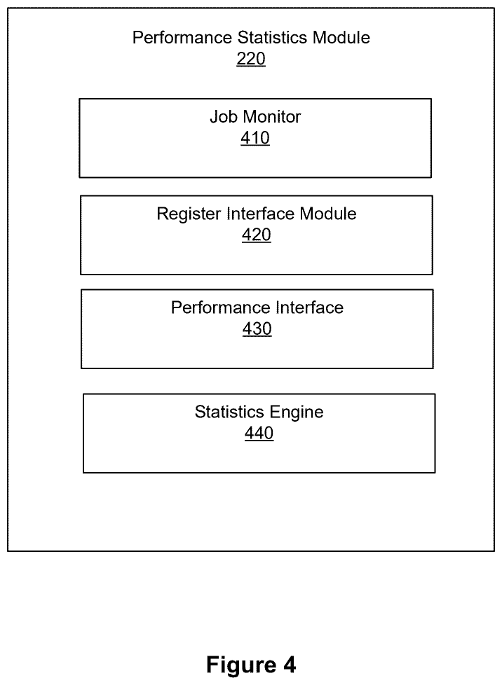

FIG. 4 illustrates one embodiment of a performance statistics module 220. As shown above in FIG. 4, performance statistics module 220 includes job monitor 410, register interface module 420, performance interface 430 and statistics engine 440. According to one embodiment, performance statistics module 220 receives performance data generated at a printing subsystem during printing of a print job, retrieves current performance statistics data associated with the performance data from one of a plurality of statistical registers, generates updated performance statistics data based on the performance data and the current performance statistics data and stores the updated performance statistics data in the one statistical register. Resulting technical benefits include generating updated performance statistics.

Job monitor 410 monitors the life cycle of print jobs being produced at printing system 130. In one embodiment, job monitor 410 tracks when a print job is starting, ending, and/or is cancelled at print controller 140 based on messaging received from print control 140. Additionally, job monitor 410 tracks events that occur during the print job processing. In such an embodiment, an event may comprise an event that occurred because one or more subsystems are performing an action that triggers a predetermined notification. Accordingly, a subsystem transmits a notification message to job monitor 410 upon an occurrence of an event. In some embodiments, job monitor 410 at the performance statistics module in head node 210 receives a notification message (e.g., a print job finished message indicating that a print job has finished) and in response transmits a notification message (e.g., print job finished or send statistics data) to the performance statistics module 220 at compute nodes 320 and end node 330 indicating nodes to send statistics data to the head node.

Register interface module 420 is implemented to interface and manage registers 316 (e.g., statistical registers) within memory 315. In one embodiment, registers 316 comprise key performance statistical registers implemented within memory 315 to store key performance data generated at one or more subsystems. Register interface module 420 creates and initializes a set of statistical registers 316 upon a notification message being received that indicates the start of a print job (e.g., print job begin notification message). The statistical registers are created by an allocation and assignment of registers within available memory. The statistical registers are cleared by a deallocation and release of the registers. In a further embodiment, each print job is associated with a unique print job identifier (ID) that is included in notification messages and/or key performance traces (e.g., performance statistics traces) generated as performance statistics for that job. Resulting technical benefits include timely creation and clearing of compute resources and/or tracking information. Key performance statistics data can be vector or scalar, floating point or integer values.

Register interface module 420 also clears the set of statistical registers 316 upon a notification message being received that indicates the print job has been cancelled (e.g., cancel job message). Additionally, register interface module 420 retrieves key performance statistics data stored with the set of statistical registers 316 upon a notification message being received that indicates the print job has been completed (e.g., print job finished notification message). The accessed key performance data is used to generate performance statistics. In a further embodiment, register interface module 420 clears the set of statistical registers 316 once the performance statistics data have been retrieved. Resulting technical benefits include timely accessing statistics data and/or clearing of resources when no longer needed.

Performance interface 430 operates as an interface with a subsystem to facilitate the generation of the performance data stored in statistical registers 316. In one embodiment, performance interface 430 comprises a function included within each subsystem. In such an embodiment, performance interface 430 comprises an application programming interface (API) executed within a subsystem for performance logging. In a further embodiment, performance critical subsystems implement performance interface 430 to log performance-related traces in logging module 250.

In one embodiment, logging module 250 comprises a logging database and stores (e.g., logs) traces in memory 315 that are generated at performance statistics module 220, as well as at node subsystems. In this embodiment, the traces are stored in a performance-optimized, compressed format. In a further embodiment, the compressed performance data may be broadcast over a network (e.g., network 305) during print production. However, in this or other embodiments, the compressed performance data may be stored to disk after the completion of print production.

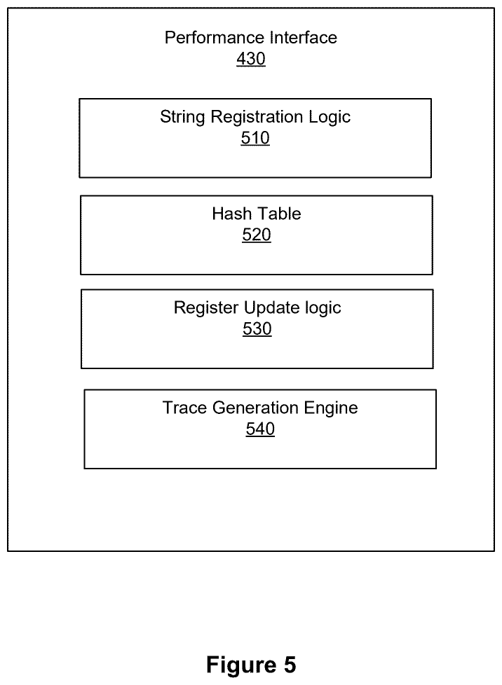

FIG. 5 illustrates one embodiment of performance interface 430. As shown in FIG. 5, performance interface 430 includes string registration logic 510, hash table 520, register update logic 530 and trace generation engine 540. String registration logic 510 registers label strings. According to one embodiment, performance interface 430 is implemented to generate performance traces based on performance data generated during the processing of the print job data at a subsystem. In this embodiment, performance data may comprise a text label (or label) and binary data representing log event measurement data. A label enables the data to be human and machine readable and provides context to the data.

In one embodiment, string registration logic 510 registers data label format strings (e.g., format strings) that are expected to be included in performance data during print processing. String registration logic 510 subsequently assigns a data label to each format string and stores the data labels and format strings in hash table 520. In a further embodiment, string registration logic 510 only registers performance data label strings that have been designated as key performance data. In another embodiment, string registration logic 510 registers a plurality of print job IDs as data labels in hash table 520 to enable association of format strings with one of a plurality of print job IDs.

Register update logic 530 receives performance data from a subsystem as logging requests during print processing and searches hash table 520 using the label string in performance data to determine whether the request is associated with key performance data included in hash table 520 (e.g., having a matching label string). In one embodiment, register update logic 530 generates performance statistics data based on the performance measurement data and performance statistics data already stored in registers 316. In such an embodiment, register update logic 530 uses at least one numerical value included in the key performance data and updates performance statistics data using the data from the current performance trace.

As used herein, statistical data (e.g., statistical elements) is a genus and the corresponding species include count of data points, sum of data, sum of squares, mean (statistical mean), node maxima, node minima, minimum (minimum metadata) and maximum (maximum metadata). The resulting technical benefits of applying statistical elements include minimal computational resource requirements for updates according to running statistical algorithms, and serving as building blocks to derive higher-order statistics (e.g., variances and standard deviations). In embodiments, the statistics data may comprise statistical elements including a statistical mean, minimum value (data point) encountered, a maximum value encountered, a running sum of all the values encountered, and the sum of the squares of the values encountered, and/or a count of the values encountered. In further embodiments, register update logic 530 generates descriptive data (e.g., text) about the statistics (e.g., statistics metadata) comprising, e.g., the sheet number, page number, object type, color plane, POH instance, etc., where an extreme data value (e.g. maximum or minimum) was encountered. The generated statistics data replaces statistics data generated for a previous performance data having the same data label. For example, an updated metadata string is generated if a new value replaces a previous minimum or maximum value associated with previously received performance data. Resulting technical benefits include reduced computational burden.

According to one embodiment, register update logic 530 retrieves statistics data previously stored in registers 316 with a performance statistics data entry, generates the updated statistics data to include one or more data values included in the currently received performance data and stores the updated the statistics data, including any updated statistical metadata strings, in the same statistical register from which the current statistics data were retrieved. In a further embodiment, register update logic 530 uses the data label to store the updated performance statistics data entry in a register associated with the data label.

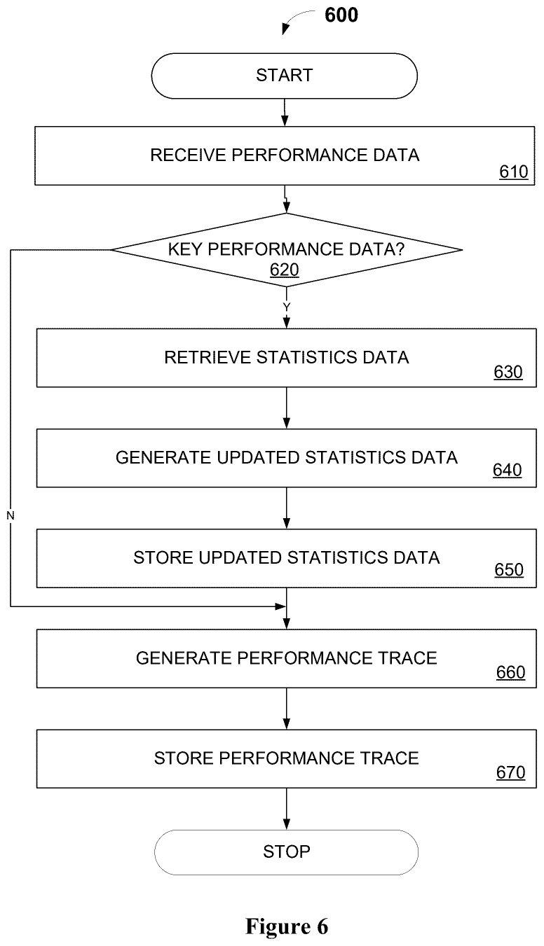

Trace generation engine 540 generates and stores a performance trace for the performance data once the statistical register has been updated. FIG. 6 is a flow diagram illustrating one embodiment of a process 600 for processing performance data. Process 600 may be performed by processing logic that may comprise hardware (e.g., circuitry, dedicated logic, programmable logic, etc.), software (such as instructions run on a processing device), or a combination thereof. In one embodiment, process 600 may be performed by performance interface 430. The process 600 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-5 are not discussed or repeated here.

Process 600 begins at processing block 610, where performance data is received from a subsystem. At decision block 620, a determination is made as to whether the performance data comprises key performance data. As discussed above, performance data having a label string that matches a label string in hash table 520 is considered key performance data. Statistics data (e.g., statistics metadata) is retrieved from registers 316 upon a determination at decision block 620 that the performance data is key performance data, processing block 630.

At processing block 640, updated statistics data is generated based on the performance measurement data and the retrieved statistics data (e.g., the retrieved current statistics data). At processing block 650, the updated statistics data is stored in registers 316 corresponding to the retrieved statistics data.

At processing block 660, a performance trace is generated based on the performance data. At processing block 670, the performance trace is stored (e.g., via logging module 250). Upon a determination at decision block 620 that performance data is not key performance data, control is forwarded directly to processing blocks 660 and 670 (bypassing steps 630, 640 and 650) where a performance trace is generated and stored, respectively. Resulting technical benefits include reducing computational burden through bypassing the updating of statistical data for performance data that is not key.

Referring back to FIG. 4, statistics engine 440 generates performance statistics upon receiving a print job finished message. In one embodiment, statistics engine 440 determines whether it is operating in a head node 310. If operating in a compute node 320 and end node 330, statistics engine 440 finalizes statistics. In this embodiment, the statistics are finalized by accessing registers 316 to retrieve current statistics data for the one or more subsystems associated with the performance statistics module 220 in which statistics engine 440 resides. Finalizing statistics data include converting statistical elements into other statistical elements as instructed. Subsequently, statistics engine 440 transmits the finalized statistics to head node 310 followed by clearing statistical registers corresponding to the node. Resulting technical benefits include timely accessing statistics data and/or clearing of computational resources when no longer needed.

If operating in a head node 310, statistics engine 440 forwards the print job finished message to compute nodes 320 and end node 330 prior to finalizing the statistics data. Subsequently, statistics engine 440 in the head node 310 determines whether statistics data for all nodes have been collected. According to one embodiment, statistics engine 440 merges statistics data upon receiving a message from job monitor 410 indicating that all remote statistics data have been received (e.g., from all compute nodes 320 and end node 330). As used herein, merging statistics data includes statistically combining a plurality of statistics data that correspond to the same performance indicator (e.g., rasterization performance statistics data for a first node and a second node). In other embodiments, the head node perf process waits for messages from remote node perf processes containing their finalized performance statistics. Upon receiving these messages, the head node perf process merges remote node performance statistics into global performance statistics for each print job. Upon determining that all remote node performance statistics have been received, the head node perf process enters global performance statistics in the traces and records them in the job database, or causes job monitor to record them in the job database. In this way, global (for all nodes) performance statistics are recorded in traces and in a database for every print job that runs to completion.

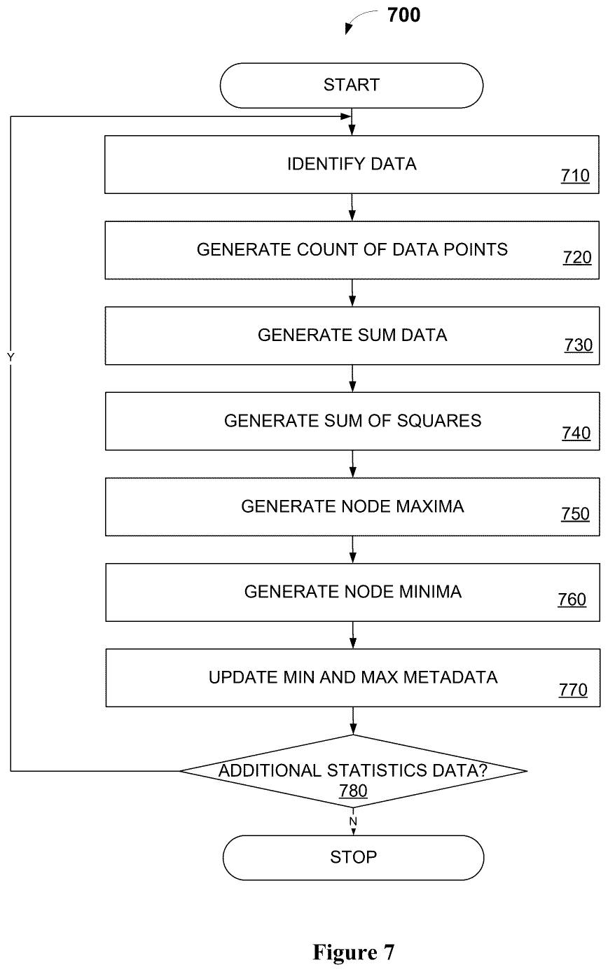

FIG. 7 is a flow diagram illustrating one embodiment of a process 700 for generating updated statistics and corresponds to step 640 in process 600. Process 700 may be performed by processing logic that may comprise hardware (e.g., circuitry, dedicated logic, programmable logic, etc.), software (such as instructions run on a processing device), or a combination thereof. In one embodiment, process 700 may be performed by statistics engine 440. The process 700 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-6 are not discussed or repeated here.

Process 700 begins at processing block 710, where current statistics data from registers 316 and performance data is identified. At processing block 720, updated count of data points statistics data is generated. At processing block 730, updated sum of data points statistic data is generated. At processing block 740, updated sum of squares statistics data (e.g., the sum of squared differences from the mean) is generated. At processing block 750, updated node maxima statistics data is generated. At processing block 760, updated node minima statistics data is generated. In a further embodiment, other statistics data species (e.g., statistical mean, etc.) may also be processed and updated in like corresponding steps. At processing block 770, updated minimum and maximum metadata statistics data is generated. At decision block 780, a determination is made as to whether additional statistics are available. If so, control is returned to processing block 710 where statistics data is received. Otherwise, process 700 is completed. It is understood that in steps 720 through 770 inclusive, the generated updated statistical data is based on the corresponding statistics data and the corresponding performance data.

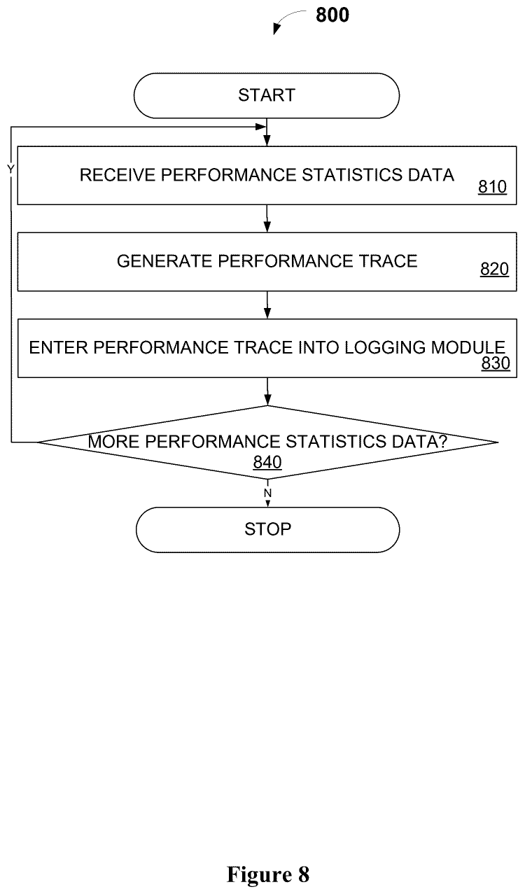

Referring back to FIG. 4, statistics engine 440 records the merged statistics as performance statistics. In one embodiment, the merged performance statistics comprises performance statistics received from each node (e.g., compute nodes 320 and end node 330). FIG. 8 is a flow diagram illustrating one embodiment of a process 800 for generating performance statistics traces. Process 800 may be performed by processing logic that may comprise hardware (e.g., circuitry, dedicated logic, programmable logic, etc.), software (such as instructions run on a processing device), or a combination thereof. In one embodiment, process 800 may be performed by statistics engine 440. The process 800 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-7 are not discussed or repeated here.

Process 800 begins at processing block 810, where performance statistics data is received. At processing block 820, a performance trace is generated based on the performance statistics data. At processing block 830, the performance trace is entered into logging module 250. At decision block 840, a determination is made as to whether additional performance statistics data is available. If so, control is returned to processing block 810 where performance statistics data is received. Otherwise, process 800 is completed.

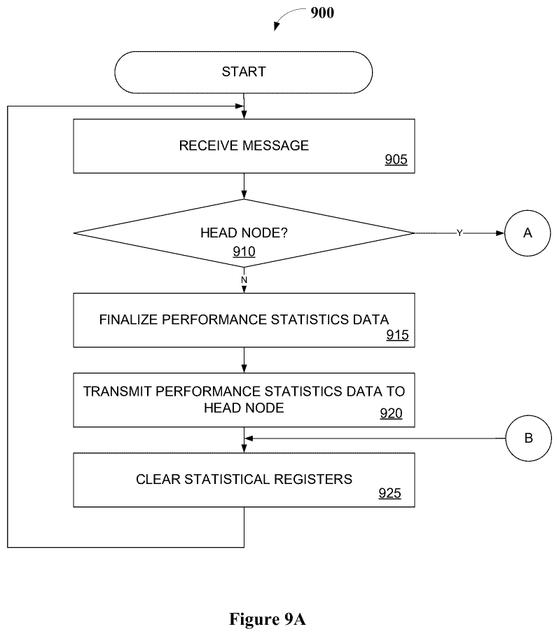

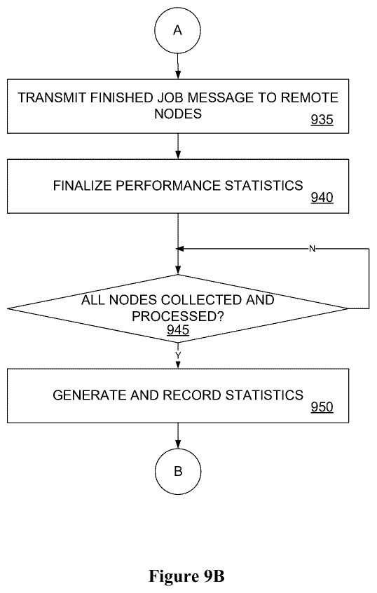

FIGS. 9A and 9B is a flow diagram illustrating one embodiment of a process 900 for generating performance statistics performed upon completion of a print job. Process 900 may be performed by processing logic that may comprise hardware (e.g., circuitry, dedicated logic, programmable logic, etc.), software (such as instructions run on a processing device), or a combination thereof. In one embodiment, process 900 may be performed by statistics engine 440. The process 900 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-8 are not discussed or repeated here.

Process 900 begins at processing block 905 (FIG. 9A), where a print job finished notification message is received. At decision block 910, a determination is made as to whether the node of the performance statistics module at which the notification message is being received is the head node. Performance statistics data corresponding to the node is finalized upon a determination that the node is not the head node, processing block 915. At processing block 920, the finalized performance statistics data corresponding to the node is transmitted to the head node. Resulting technical benefits include allowing for coordinated distributed processing (e.g., processing with different types of nodes). At processing block 925, the statistical registers corresponding to the node are cleared, and control is returned to processing block 905 for receipt of another notification message.

At processing block 940 (FIG. 9B), the performance statistics corresponding to the head node are finalized in response to a determination that the node is a head node.

At decision block 945, a determination is made as to whether the performance statistics data for all nodes has been collected and processed. If so, the final performance statistics data is generated and recorded (e.g., stored) at processing block 950. At processing block 950 a performance statistics report comprising the final statistics data may be processed (e.g., assembled, formatted, and/or annotated) and made available (e.g., stored, transmitted and/or displayed). Resulting technical benefits include making the final statistics available to the user. Subsequently, control is returned to processing block 925, where the statistical registers of the head node are cleared. Control is returned to decision block 945 to await performance statistics data upon a determination at decision block 945 that the performance statistics data for all nodes has not been collected and processed.

It is understood that processes 600, 700, 800 and 900 may be performed on a per print job ID basis based on the print job ID included in notification messages and/or key performance traces generated as performance statistics for that job.

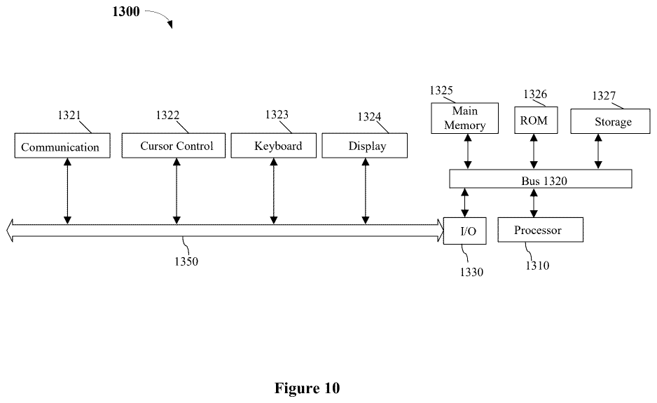

FIG. 10 illustrates a computer system 1300 on which printing host 110, printing system 130, print controller 140 and/or compute resources 190 may be implemented. Computer system 1300 includes a system bus 1320 for communicating information, and a processor 1310 coupled to bus 1320 for processing information.

Computer system 1300 further comprises a random access memory (RAM) or other dynamic storage device 1325 (referred to herein as main memory), coupled to bus 1320 for storing information and instructions to be executed by processor 1310. Main memory 1325 also may be used for storing temporary variables or other intermediate information during execution of instructions by processor 1310. Computer system 1300 also may include a read only memory (ROM) and/or other static storage device 1326 coupled to bus 1320 for storing static information and instructions used by processor 1310.

A data storage device 1327 such as a magnetic disk or optical disc and its corresponding drive may also be coupled to computer system 1300 for storing information and instructions. Computer system 1300 can also be coupled to a second I/O bus 1350 via an I/O interface 1330. A plurality of I/O devices may be coupled to I/O bus 1350, including a display device 1324, an input device (e.g., a keyboard 1323 (e.g., alphanumeric input device) and/or a cursor control device 1322). The communication device 1321 is for accessing other computers (servers or clients). The communication device 1321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes at least one physical memory device to store performance statistics logic and one or more processors coupled with the at least one physical memory device to execute the performance statistics logic to receive performance data generated at a printing subsystem during printing of a print job, retrieve current performance statistics data associated with the performance data from one of a plurality of statistical registers, generate updated performance statistics data based on the performance data and the current performance statistics data and store the updated performance statistics data in the one statistical register.

Example 2 includes the subject matter of Example 1, wherein the performance statistics logic further to retrieve a plurality of performance statistics data from each of the plurality of statistical registers, and generate a performance statistics report based on the plurality of performance statistics data.

Example 3 includes the subject matter of Examples 1 and 2, wherein the performance data comprises one of a plurality of data labels and the one statistical register is identified by matching the one data label to a statistical register corresponding to the one data label.

Example 4 includes the subject matter of Examples 1-3, wherein the performance data comprises one of a plurality of measurement data and generating the updated performance statistics data comprises updating the current performance statistics data to include the one measurement data.

Example 5 includes the subject matter of Examples 1-4, wherein the performance statistics logic further to generate a performance trace based on the performance data and store the performance trace.

Example 6 includes the subject matter of Examples 1-5, wherein the performance statistics logic further to determine whether the performance data comprises key performance data and retrieve the current performance statistics data upon a determination that the performance data comprises key performance data.

Example 7 includes the subject matter of Examples 1-6, wherein the determining whether the performance data comprises key performance data comprises accessing a hash table to determine whether the data label matches a data label in the hash table.

Example 8 includes the subject matter of Examples 1-7, wherein the performance statistics logic further to generate the performance trace and bypass generating updated performance statistics data upon a determination that the performance data does not comprise key performance data.

Example 9 includes the subject matter of Examples 1-8, wherein the performance statistics logic further to generate each of the plurality of statistical registers corresponding to each of the plurality of data labels upon receiving a print job begin notification message.

Example 10 includes the subject matter of Examples 1-9, wherein the performance statistics logic further to retrieve performance statistics data from the plurality of statistical registers upon receiving a print job finished notification message and transmit the performance statistics data to a head node.

Example 11 includes the subject matter of Examples 1-10, wherein performance statistics data comprises a count of data points and generating the updated performance statistics data comprises updating the count of data points in the updated performance statistics.

Example 12 includes the subject matter of Examples 1-11, wherein the performance statistics data further comprises a statistical mean and generating the updated performance statistics data further comprises updating the statistical mean in the updated performance statistics.

Example 13 includes the subject matter of Examples 1-12, wherein the performance statistics data further comprises a minimum and a maximum and generating the updated performance statistics data further comprises updating the minimum and the maximum in the updated performance statistics.

Example 14 includes the subject matter of Examples 1-13, wherein the performance statistics logic further to determine that an associated processing node is not a head node upon receiving a print job finished notification message and transmit the final performance data to the head node.

Example 15 includes the subject matter of Examples 1-14, wherein the performance statistics logic further to clear the statistical register after transmitting the final performance data to the head node.

Example 16 includes the subject matter of Examples 1-15, wherein the performance statistics logic further to clear the statistical register upon receiving a print job cancel notification message.

Example 17 includes the subject matter of Examples 1-16, further comprising a printer to print the print job.

Some embodiments pertain to Example 18 that includes at least one computer readable medium having instructions stored thereon, which when executed by one or more processors, cause the processors to receive performance data generated at a printing subsystem during printing of a print job, retrieve current performance statistics data associated with the performance data from one of a plurality of statistical registers, generate updated performance statistics data based on the performance data and the current performance statistics data and store the updated performance statistics data in the one statistical register.

Example 19 includes the subject matter of Example 18, wherein the performance statistics logic further to retrieve a plurality of performance statistics data from each of the plurality of statistical registers, and generate a performance statistics report based on the plurality of performance statistics data.

Some embodiments pertain to Example 20 that includes a method comprising receiving performance data generated at a printing subsystem during printing of a print job, retrieving current performance statistics data associated with the performance data from one of a plurality of statistical registers, generating updated performance statistics data based on the performance data and the current performance statistics data and storing the updated performance statistics data in the one statistical register.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
at least one physical memory device to store performance statistics logic; and
one or more processors coupled with the at least one physical memory device to execute the performance statistics logic to:
receive performance data generated at a printing subsystem during printing of a print job;
retrieve current performance statistics data associated with the performance data from one of a plurality of statistical registers;
generate updated performance statistics data based on the performance data and the current performance statistics data; and
store the updated performance statistics data in the one statistical register.

2. The system of claim 1, wherein the performance statistics logic further to retrieve a plurality of performance statistics data from each of the plurality of statistical registers, and generate a performance statistics report based on the plurality of performance statistics data.

3. The system of claim 1, wherein the performance data comprises one of a plurality of data labels and the one statistical register is identified by matching the one data label to a statistical register corresponding to the one data label.

4. The system of claim 3, wherein the performance data comprises one of a plurality of measurement data and generating the updated performance statistics data comprises updating the current performance statistics data to include the one measurement data.

5. The system of claim 3, wherein the performance statistics logic further to:
generate a performance trace based on the performance data; and
store the performance trace.

6. The system of claim 5, wherein the performance statistics logic further to:
determine whether the performance data comprises key performance data; and
retrieve the current performance statistics data upon a determination that the performance data comprises key performance data.

7. The system of claim 6, wherein the determining whether the performance data comprises key performance data comprises accessing a hash table to determine whether the data label matches a data label in the hash table.

8. The system of claim 6, wherein the performance statistics logic further to generate the performance trace and bypass generating updated performance statistics data upon a determination that the performance data does not comprise key performance data.

9. The system of claim 1, wherein the performance statistics logic further to generate each of the plurality of statistical registers corresponding to each of the plurality of data labels upon receiving a print job begin notification message.

10. The system of claim 1, wherein the performance statistics logic further to:
retrieve performance statistics data from the plurality of statistical registers upon receiving a print job finished notification message; and
transmit the performance statistics data to a head node.

11. The system of claim 1, wherein performance statistics data comprises a count of data points and generating the updated performance statistics data comprises updating the count of data points in the updated performance statistics.

12. The system of claim 11, wherein the performance statistics data further comprises a statistical mean and generating the updated performance statistics data further comprises updating the statistical mean in the updated performance statistics.

13. The system of claim 11, wherein the performance statistics data further comprises a minimum and a maximum and generating the updated performance statistics data further comprises updating the minimum and the maximum in the updated performance statistics.

14. The system of claim 1, wherein the performance statistics logic further to:
determine that an associated processing node is not a head node upon receiving a print job finished notification message; and
transmit the final performance data to the head node.

15. The system of claim 14, wherein the performance statistics logic further to clear the statistical register after transmitting the final performance data to the head node.

16. The system of claim 1, wherein the performance statistics logic further to clear the statistical register upon receiving a print job cancel notification message.

17. The system of claim 1, further comprising a printer to print the print job.

18. At least one computer readable medium having instructions stored thereon, which when executed by one or more processors, cause the processors to:
receive performance data generated at a printing subsystem during printing of a print job;
retrieve current performance statistics data associated with the performance data from one of a plurality of statistical registers;
generate updated performance statistics data based on the performance data and the current performance statistics data; and
store the updated performance statistics data in the one statistical register.

19. The computer readable medium of claim 18, wherein the performance statistics logic further to retrieve a plurality of performance statistics data from each of the plurality of statistical registers, and generate a performance statistics report based on the plurality of performance statistics data.

20. A method comprising:
receiving performance data generated at a printing subsystem during printing of a print job;
retrieving current performance statistics data associated with the performance data from one of a plurality of statistical registers;
generating updated performance statistics data based on the performance data and the current performance statistics data; and
storing the updated performance statistics data in the one statistical register.
